(19) United States
(12) Patent Application Publication
(10) Pub. No.: US 2005/0023334 A1
(43) Pub. Date: Feb. 3, 2005

(54) Packing crate

(76) Inventors: Il-Dong Park, Seoul (KR); Seong-Yong Kim, Hwasung-city (KR)

Correspondence Address: Robert E. Bushnell, Suite 300, 1522 K Street, N.W., Washington, DC, 20005, US

(21) Appl. No.: 10/669,747

(22) Filed: Sep. 25, 2003

(30) Foreign Application Priority Data
Jul. 30, 2003 (KR) 2003-52691

(51) Int. Cl. B65D 5/12; B65D 5/28; B65D 5/32; B26D 5/42

(52) U.S. Cl. 229/122.21; 229/198.1

(57) ABSTRACT

A packing crate made of paper, an adhesive and thread sewn into the paper and a method for making the same. The crate protects the goods outside and inside from damage, has a good appearance, and can withstand sudden temperature and humidity changes. The crate folds piled up Kraft paper and/or the corrugated paper, etc. and stitches the paper together. One or two lines of stitches, 50 to 80 stitches per meter, the thread having a thickness of 300D/3 to 500D/3, the thread being a thick synthetic fiber. The stitches are made before the adhesive fully dries.

### CLAIM OF PRIORITY

This application makes reference to, incorporates the same herein, and claims all benefits accruing under 35 U.S.C. §119 from an application for A CRATE earlier filed in the Korean Intellectual Property Office on 30 Jul. 2003 and there duly assigned Serial No. 2003-52691.

### BACKGROUND OF THE INVENTION

1. Field of the invention

The present invention relates to a packing crate, more precisely, to a packing crate made of paper, and a novel structure and method of making that can withstand environment changes, safely protect goods, and is easy and safe to open.

2. Description of the Related Art

Packing crates can be made of paper, for example Kraft paper and/or corrugated paper. However, seldom are crates made of a single piece of paper or corrugation. Often, different sheets of paper or corrugation are used for different sides of the crate. These sides must be attached to each other. To do this, often a strip on one side is folded over to be parallel to and to mate with a sheet or stack of sheets for another side of the crate. What is key is how this folded strip from one side is attached to the material on the adjoining side of the crate.

Packing crates used to carry goods for import or export suffer many drawbacks. Often, such crates use metallic staples or metallic nails to close the crates or to attach one side to another. The problem is that the metallic staples can get rusted and thus damage goods within the crate or goods located near the crate with the rusted metal. Other problems occur when an adhesive is used to seal a crate. If the crate is moved in and out of freezers or refrigerators, the adhesion delaminates and then the crate may fall apart. Any change in temperature or humidity can cause hardened adhesion to undo, exposing the goods inside the crate. Also, any holes produced in the crate can cause unwanted moisture and humidity to enter the crate jeopardizing the integrity of the goods inside the crate. Also, crates require a person to use a sharp instrument such as a knife to open the crate. Therefore, what is needed is an improved crate design to overcome the above problems.

### SUMMARY OF THE INVENTION

It is therefore an object of the present invention to provide an improved design for a packing crate.

It is also an object of the present invention to provide an improved method of making and sealing a packing crate.

It is further an object of the present invention to provide a design for a packing crate that is absent any metallic objects thus preventing the occurrence of rust during shipping or storage.

It is still an object of the present invention to provide a design for a packing crate that can withstand sudden temperature changes and humidity changes.

It is further an object of the present invention to provide a design for a packing crate that doesn't require sharp tools to open.

It is still yet another object of the present invention to provide a design for a packing crate that can be easily opened.

It is also an object of the present invention to provide a design for a packing crate that can be opened without causing danger to the person opening the crate and without jeopardizing the integrity of the contents of the crate during opening.

It is yet another object of the present invention to provide a design for a packing crate that does not allow air and/or moisture to enter the crate during shipping and/or storage.

It is also an object of the present invention to provide a packing crate that has an appealing appearance.

These and other objects may be achieved by a packing crate that uses adhesive and sewn thread to seal. The packing crate is manufactured by sewing the edge part that is overlapped finally after folding the paper goods made by piling up the Kraft paper and/or the corrugated paper, etc. The paper is sewn together such that there are between 50 and 80 stitches per meter. Each seam has either one or two lines of sewn thread. The thread is made out of a synthetic fiber that has a thickness between 300D/3˜500D/3. The packing crate is sewn together using an industrial sewing machine. It is preferred to apply the adhesive prior to sewing, and it is preferred to sew before the adhesive dries so that the holes created by the sewing machine can be sealed by the adhesive.

### BRIEF DESCRIPTIONS OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 illustrates how different portions of a packing crate can fit together;

FIGS. 2 and 3 illustrate a sample view illustrating an edge part of a packing crate;

FIG. 4 illustrates a sample view for an embodiment illustrating an edge part of a packing crate according to an embodiment of the present invention;

FIG. 5 illustrates a perspective view of a packing crate according to an embodiment of the present invention; and

FIG. 6 illustrates a close-up view of portion A part of FIG. 5.

### DETAILED DESCRIPTION OF THE INVENTION

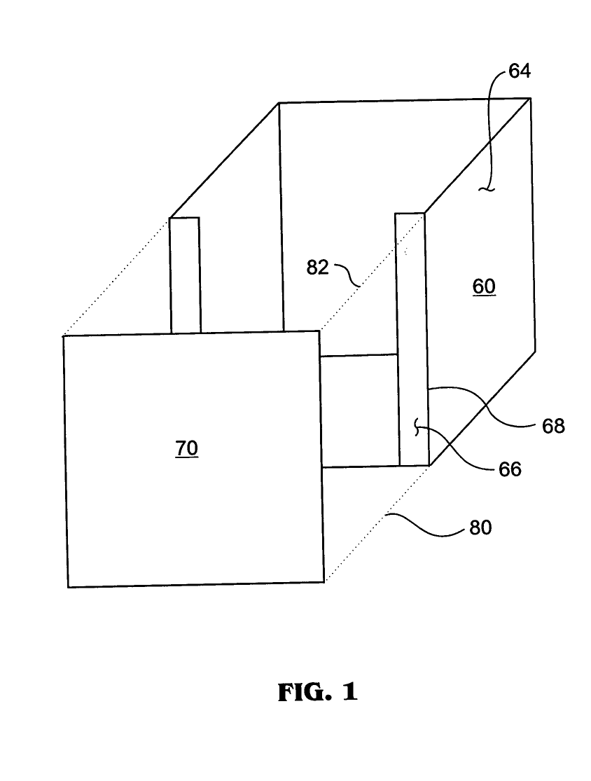

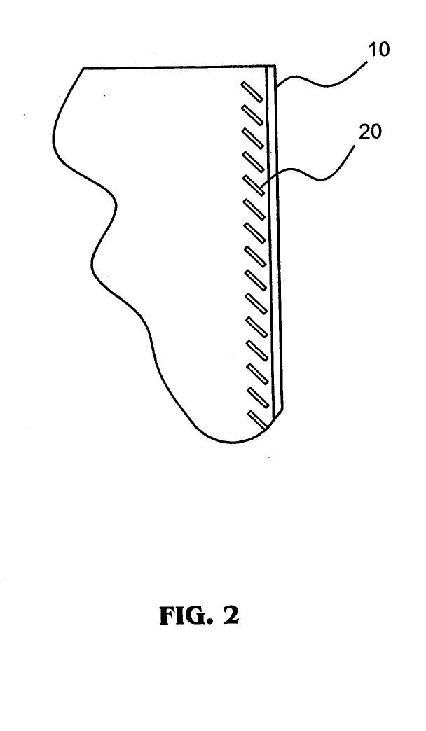

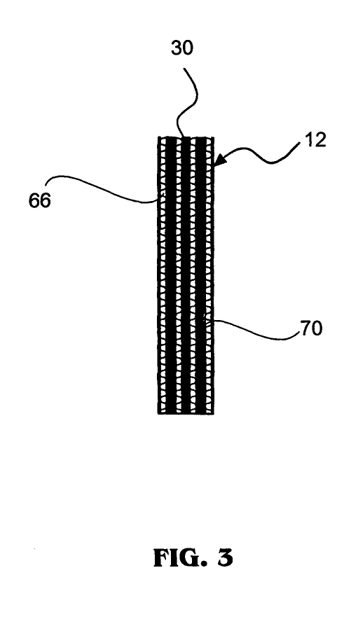

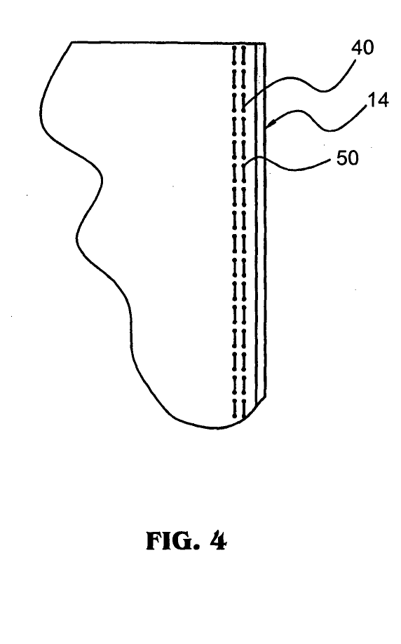

Turning to the figures, FIG. 1 illustrates how a packing crate can be made up of more than one piece of a material bound together. As illustrated in FIG. 1, two sides 60 and one front portion 70 of a packing crate are illustrated. The front end of the side portions 60 are folded at fold 68 so that a strip 66 is formed parallel to front portion 70 and is perpendicular to side portion 64 of sides 60. When a crate is made, the front side of strips 66 are in contact with a back side of front portion 70. As illustrated by connecting lines 80 and 82, front portion 70 is attached to strips 66 via staples as illustrated in FIG. 2, adhesive as illustrated in FIG. 3 and using thread and adhesive according to the present invention as illustrated FIGS. 4 through 6. Side portions 60 and front portion 70 can be made of stacks of Kraft paper, corrugated paper or any other suitable material.

Turning now to FIG. 2, FIG. 2 illustrates a packing crate 10 for cargo, is manufactured by filing and polishing up the edges of overlapping material using staples 20 from a stapler as illustrated in FIG. 2, or by applying an adhesive 30 as illustrated in FIG.3. Of the two types of crates as mentioned above, the use of staples is advantageous in that it is very simple to manufacture. On the other hand, the stapled crate of FIG. 2 is disadvantageous in that it is not aesthetically attractive. The stapled crate of FIG. 2 is also disadvantageous because the goods stored near a stapled crate can be damaged because the staples are often metallic and thus can rust. The rust can be exacerbated by salt from the ocean that reacts with the metallic staples. Rusty staples can cause damage to nearby goods as well as goods within the crate. Also, rusty nails and staples are unsightly.

The crate 12 of FIG. 3 using adhesive 30 is advantageous in that it is easy to manufacture. The crate of FIG. 3 is disadvantageous in that the crate is not sturdy. The crate if FIG. 3 is also disadvantageous in that the adhesion 30 can become undone when the crate is moved in and out of refrigerators and freezers subjecting the crate and the adhesion to large temperature and humidity swings. When the crate 12 of FIG. 3 having adhesion experiences huge temperature and humidity swings, the crate can become undone and can open and thus jeopardize the integrity of the contents.

In addition to the above, problems also occur when attempting to open the crates of FIGS. 2 and 3. Often, a knife is required to open the crates of FIGS. 2 and 3. The knife can damage the goods inside the crate. Also, in the case of the packing crate of FIG. 2, the knife can run into the metallic staples and create difficulty in opening the crate and the knife can also pose a safety problem for the person trying to open the crate. Crates made out of metal or a synthetic resin may be more suitable containers for liquid or powder cargo than Kraft paper crates or corrugated paper crates.

The packing crate 14 of the present invention uses thread 40 to seal the crate as illustrated in FIG. 3. The thread must have a thickness between 300D/3 and 500D/3. XxxD/y has the following meaning. “D” means “denier”, and denier is an indication of the mass of the thread per unit length or fineness of the thread. The numerator xxx is the number of grams per 9 km. The denominator y or “3” is the number of strands in the thread. If thread of a thickness of less than 300D/3 is used, the paper to which the thread is sewn to gets torn easily by the narrow thread cutting into the paper. On the other hand, if the thickness of the thread is greater than 500D/3, a thicker needle is needed to sew the thread to the crate because the hole in the needle must be big enough to allow the thread to pass through. Because the needle is so big, the needle produces large pinholes 50 when the thread is sewn to the crate. If the needle is too large, these large holes are large enough to allow large amounts of air and moisture to gain entry into the crate, compromising the integrity of the contents of the crate.

In the present invention, it is preferred to have 50 to 80 stitches per meter. If there is less than 50 stitches/meter, then there is a problem that the attachment using the thread is unstable because the interval between stitches becomes too large. If more than 80 stitches per meter are sewn into the crate, the paper can be more easily torn. Also, if more than 80 stitches per meter are present, too much thread is used up. Therefore, it is optimal to have between 50 and 80 stitches per meter.

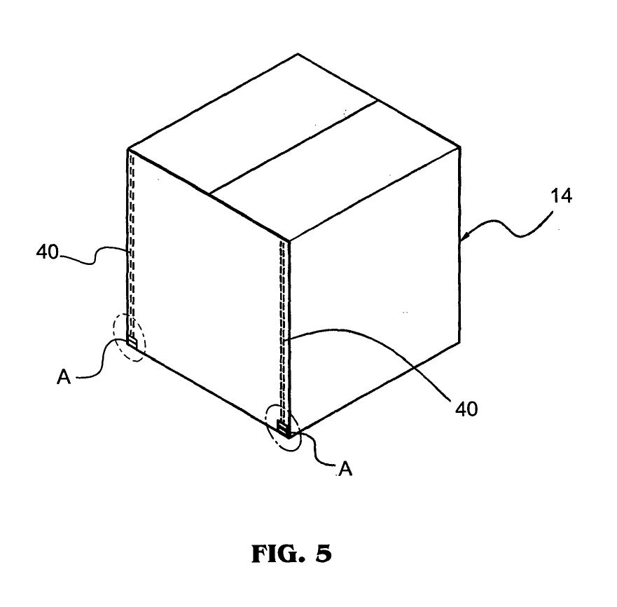

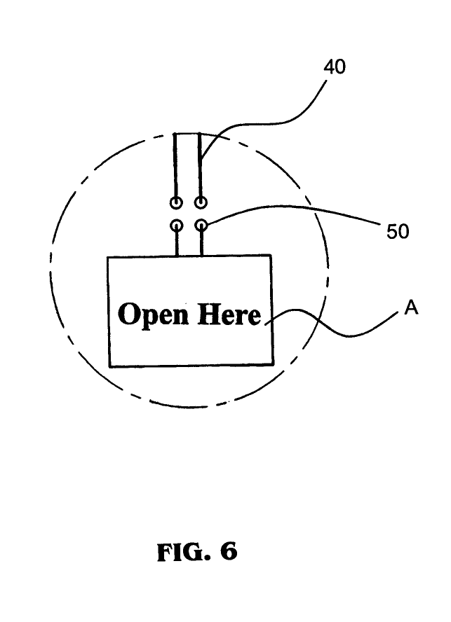

Another feature of the present invention is the ability of a person to open the crate by causing the sewn thread to unravel. If the crate is small, it is preferable that the crate be designed so that no one can undo the sewn thread. However, if the crate is large, and the crate contains heavy equipment, it is preferable that the crate is made easy to open. In such a scenario, a tab is formed on the crate where the user can pull when the user wants to open the crate. By pulling the tab, the stitches become undone and the paper is torn like in a fertilizer bag. Preferably, the tab is made using synthetic resin and/or a sticker so that the tab does not flutter. Also, it is preferable to mark the tab with a message like “open here” so as to be more user friendly (see section A of FIGS. 5 and 6).

Furthermore, in the packing crate of the present invention, it is preferable to use an adhesive with the thread. Since the needle of the thread produces holes in the paper, and because these holes, if not properly sealed, can cause moisture and air to enter, it is preferable to seal these holes with an adhesive. Preferably, it is best to apply adhesive before sewing the thread into the paper. It is preferable to sew the thread into the paper before the adhesive is given a chance to fully dry so that the adhesive can seal the holes created by the sewing. It is preferable that the thread is a synthetic fiber made of one of nylon (polyamide), polyester, or polypropylene synthetic resin. It is necessary to use the thread in addition to the adhesive as using adhesive without the thread will result in the adhesive being delaminated if the packing crate is moved in and out of freezers or refrigerators subjecting the packing crate to sudden changes in temperature and humidity. Therefore, the stitches in combination with the adhesive in a packing crate is the subject of the present invention.

In addition to the above, it is preferred to have the crate made out of either Kraft paper or corrugated paper. Kraft paper is a paper produced by a modified sulfate process and employing only wood pulp. Kraft paper is a relatively coarse paper and is known especially for its strength. Kraft paper is usually manufactured on a Fourdrinier machine and can be finished with a regular machine finish or a machine-glazed surface. Since, in the present invention, an attractive glossy finish is preferred, a machine-glazed surface is preferred over a regular machine finish but either finish will work. The natural unbleached color for Kraft paper is brown.

Three different embodiments have been contemplated and will now be discussed:

### FIRST EMBODIMENT

A packing crate according to a first embodiment is made by sewing the end edge stitching part into 80 stitches/m using only one line of stitches and using a synthetic fiber of 450D/3 for the thread. The packing crate of the first embodiment of the present invention is formed by folding a paper that has 20 mm thickness and made according to piling up Kraft paper and the corrugated paper. If the crate is constructed according to the first embodiment of the present invention, the crate can be moved many times in and out of a freezer or a refrigerator without causing the crate to fall apart.

### SECOND EMBODIMENT

A packing crate of the second embodiment is similar to the packing crate of the first embodiment except that polypropylene 400D/3 is used as the sewing thread of crate, the number of stitches being 50 stitches per meter and two lines of stitches 4 are made as illustrated in FIG. 5. Like embodiment 1, the crate has a glossy appearance that does not change when subjected to climatic changes.

### THIRD EMBODIMENT

In the third embodiment, the packing crate is manufactured similar to the first embodiment except that nylon 100D/3 is used as the sewing thread for the crate. As discussed previously, by using such a thin thread, the manufactured crate is easily and inadvertently torn by the thread. The thread penetrates through the paper of crate and the thread can also become not visible when so thin of a thread is used.

The present invention pertains to a novel design for a packing crate and a method of making the same. The novel packing crate is advantageous in that it does not contain metallic staples that are subject to rust which can cause damage to goods both within and outside the crate. Also, the crate of the present invention is easy and safe to open and does not require any knives or sharp blates or sharp instruments to open, this protecting the contents and the opener from harm and damage. Further, the packing crate of the present invention can withstand sudden changes in temperature and humidity without becoming undone. In addition, the appearance of the crate is clean and glossy and thus is appealing. The method for manufacture of the crate is also simple.

While this invention has been particularly illustrated and described with reference to preferred embodiments thereof, it will be understood by those skilled in the art that various changes in form and details may be made therein without departing from the spirit and scope of the invention is as defined by the appended claims. The preferred embodiments should be considered in descriptive sense only and not for purposes of limitation. Therefore, the scope of the invention is defined by the appended claims.

1. A packing crate, comprising:
a plurality of stacks of paper, each stack being joined with each other at an edge of said crate by folding over a strip of one stack so that it is parallel and adjacent to an adjoining stack; and
said strip from one stack being attached to said other stack via sewn thread with between 50 and 80 stitches per meter, between one and two lines of stitching, wherein the thread has a thickness between 300D/3 and 500D/3.

2. The packing crate of claim 1, the thread being selected from a group consisting of nylon, polyamide, polyester, and polypropylene.

3. The crate of claim 1, said stacks of paper being selected from the group consisting of Kraft paper and corrugated paper.

4. The packing crate of claim 1, said sewn thread ending in a tab that can be easily pulled and unraveled by a person.

5. A packing crate of claim 1, further comprised of an adhesive binding together the two stacks, said adhesive placed in a vicinity of where said sewn thread is employed.

6. The crate of claim 5, said adhesive being a synthetic resin.

7. A method of making a packing crate, comprising the steps of:
folding over a strip at an edge of a first stack of paper;
applying an adhesive to said folded over portion of said first stack of paper;
placing said folded edge with adhesive in contact with an edge of a second stack of paper; and
sewing said folded edge of said first stack to said second stack.

8. The method of claim 7, said sewing being done after application of said adhesive and before said adhesive fully dries.

9. The method of claim 7, wherein a tab is formed at one end of said strip enabling a person to undo said sewing.

10. The method of claim 7, said sewing being accomplished by an industrial grade sewing machine.

11. A packing crate forming a completely enclosed structure, said packing crate made of stacks of paper folded and attached to one another, said attaching being by sewn thread.

12. The packing crate of claim 11, further comprising an adhesive attaching said stacks to one another where said sewn thread is present, said adhesive being a synthetic resin.

13. The packing crate of claim 11, said sewn thread having 50-80 stitches per meter.

14. The packing crate of claim 11, said thread being selected from a group consisting of nylon, polyamide, polyester, and polypropylene.

15. The packing crate of claim 11, said thread having a thickness of 300D/3 to 500D/3.

16. The packing crate of claim 11, said stacks of paper being stacks of Kraft paper.

17. The packing crate of claim 11, said stacks of paper being corrugated paper.

18. The packing crate of claim 11, said crate being absent of metallic staples and metallic nails.
